(19) United States
(12) Patent Application Publication
(10) Pub. No.: US 2011/0266270 A1
(43) Pub. Date: Nov. 3, 2011

(54) METHOD FOR OPERATING AN HYDRAULIC BRAKE SYSTEM IN A MOTOVEHICLE

(76) Inventors: Thomas Loeffler, Obersulm (DE); Andreas Reize, Adelsheim (DE); Frank Kaestner, Bietigheim-Bissingen (DE); Siegfried Huber, Heilbronn (DE); Markus Hutt, Flein (DE)

(21) Appl. No.: 12/998,386

(22) PCT Filed: Aug. 26, 2009
(86) PCT No.: PCT/EP2009/060991

§ 371 Date: Jul. 20, 2011

(30) Foreign Application Priority Data
Oct. 22, 2008 (DE) 102008043037.4

(51) Int. Cl. H05B 1/00

(52) U.S. Cl. 219/202

(57) ABSTRACT

In a method for operating an hydraulic brake system in a vehicle, which has at least two electrically actuable hydraulic valves, the hydraulic valves are energized at a different current intensity at least intermittently in order to heat the hydraulic fluid during a heating period.

### BACKGROUND OF THE INVENTION

1. Field of the Invention

The present invention relates to a method for operating an hydraulic brake system in a vehicle.

2. Description of Related Art

From published German patent application document DE 10 2005 046 652 A1, a method is known for operating a brake system of motor vehicles, which is equipped with electrically controllable hydraulic valves, whose coils are energized at least intermittently in order to heat the hydraulic fluid contained in the hydraulic system. The energization is carried out when the temperature of the hydraulic fluid is below a threshold value. The energization takes place in two consecutive heating phases such that the coil temperature corresponds to a specified coil temperature value at the end of the first heating phase and the coil temperature is kept at least approximately constant during the second heating phase.

From published German patent application document DE 101 63 524 A1, a method for controlling a brake device in a motor vehicle is known, in which the hydraulic valves are likewise energized in phases, also in order to reduce the viscosity of the hydraulic fluid. According to one variant mentioned in published German patent application document DE 101 63 524 A1, the energization takes place by current pulses which are high enough to open the particular valve if it is closed in a deenergized state, or to close it when it is open in a deenergized state. Thus, a heating phase is made up of a sequence of a plurality of pulses interrupted by pauses.

The energization is accompanied by noise, especially when the current pulse is large enough to switch the valve, that is to say, large enough to change the mechanical state of the valve. It is true that published German patent application document DE 699 31 984 T2 mentions the possibility of supplying the hydraulic valves with only so little current for heating the hydraulic fluid that the mechanical state of the valves does not change. At a lower energization, however, the energy input into the hydraulic fluid is lower, so that the temperature rise is slower as well, and/or a lower temperature level is achieved.

### BRIEF SUMMARY OF THE INVENTION

The present invention is based on the objective of raising the temperature in an hydraulic brake system of a vehicle in a simple and efficient manner, and to keep the accompanying noise development as low as possible at the same time.

The present invention is used for hydraulic vehicle brake systems having at least two electrically actuable hydraulic valves, especially electromagnetic valves, which are intermittently supplied with electrical energy for heating the hydraulic fluid, and for the lowering of the fluid viscosity that goes along with it, so that a more rapid pressure generation is able to be realized. According to the present invention, during a heating period for heating the hydraulic fluid, the hydraulic valves are energized simultaneously but, at least intermittently, at different current intensities. This procedure yields various advantages. Because of the simultaneous energization of at least two hydraulic valves, a relatively high energy input into the hydraulic fluid is obtained, together with correspondingly faster heating. The different current intensities by which the hydraulic valves are energized at least intermittently leads to a phase offset between the hydraulic valves, so that a noise development that goes along with a higher current intensity and is attributable to a mechanical actuation of this valve, in particular, also takes place at one valve only. The simultaneous electromechanical actuation of two hydraulic valves at one instant, which would cause higher noise development, is therefore avoided. Instead, the switching state of the hydraulic valves is changed in alternation, so that despite the fact that the number of individual noises rises over all, the noise level is still lower than in a simultaneous actuation of two valves.

If appropriate, the current level during the phases of lower energization is so low at at least one valve that the mechanical switching state of this valve remains unchanged. According to one further development, it may likewise be useful if the current level during the phases of higher energization is also so low at at least one valve, possibly also at only a portion of the valves, that the mechanical switching state of this valve is not changed. However, in order to achieve rapid heating of the hydraulic fluid overall, this variant is preferably combined with a higher energization of at least one additional valve, during which the switching state of this additional valve changes.

Furthermore, it is possible to provide different energization profiles at which the hydraulic valves are energized for heating the hydraulic fluid. For example, it may be indicated to determine the instantaneous hydraulic fluid temperature with the aid of a temperature sensor and to specify different heating or energization profiles as a function of the instantaneous temperature level. For a rapid temperature rise, for instance, a current profile having a rapid sequence of high current pulses is initially applied at each hydraulic valve; these high current pulses may actually bring about a change in the mechanical switching state, but they accelerate the heating at the same time. According to the present invention, the high current pulses of different valves take place at a mutual phase offset in order to prevent the simultaneous opening or closing of two hydraulic valves, which would lead to greater noise.

Once the hydraulic temperature has been brought to a higher level within a relatively short period of time, the further heating or energization strategy may be modified such that, for example, the phases having higher energization are spaced further and further apart and/or the current level is lowered during the higher energization phases and possibly in the phases having lower energization as well.

The advantage of energizing the at least two hydraulic valves using different current intensities consists of the more homogenous energy transfer to the hydraulic fluid and the more uniform heating of the fluid that accompanies it.

According to one preferred specific embodiment, each hydraulic valve participating in the heating of the hydraulic fluid is acted upon by alternating phases of high and low current intensity. This advantageously prevents overheating of the hydraulic valves, because during the lower energization phase there is also less heat development. The energization peaks in the hydraulic valves advantageously lie at a mutual phase offset in order to avoid that mechanically caused noises during the change of the switching state of the hydraulic valves occur at the same time. However, in order to prevent cooling or flattening of the temperature rise of the hydraulic fluid in the meantime, it may be useful to have the phases of high current intensities in different hydraulic valves follow each other immediately, i.e., without any dead times between them. For one, this avoids the problem of increasing noise, while the high heat output in each hydraulic valve takes place in immediate succession for another, which leads to a more rapid temperature increase over all.

According to one further useful development, the duration of the phases of lower current intensity increases from phase to phase, whereas the duration of the phases of high current intensity remains constant. The unvarying duration during the high current intensity phases ensures a high energy input across the entire heating period, while the increasing duration of the phases lying in-between the current peaks takes the continuously rising temperature into account. This achieves a roughly asymptotic approximation of the hydraulic temperature to a desired temperature level, at an acceptable energy expenditure.

Various functions may be selected for the rise of the current in the transition from a phase of lower current intensity to a phase of high current intensity or vice versa. For example, ramp-type rises may be considered, preferably rises having a high gradient, up to a quasi-jump, or a corresponding drop in the current intensity. The ramp-type current change is implemented especially in the case of a change in the mechanical switching state of a hydraulic valve.

In order to achieve a rapid rise of the hydraulic temperature in particular at low ambient temperatures, it may be useful to combine individual current peaks of different valves at the beginning of the heating period, in order to thus achieve an increase in the energy input from the hydraulic valves into the hydraulic fluid. In this context it is advantageous to place the first peak directly in the phase following the startup of the drive motor of the vehicle, since the valve noise is superposed by the starting noise of the motor in such a situation. If appropriate, this first current peak is followed by one or several additional current peaks of different hydraulic valves that coincide, before the current peaks are generated at a phase offset in the further heating course in an effort to keep the additional noise development as low as possible.

According to one further useful development, the energization is to be interrupted at least once in at least one hydraulic valve during one heating period. For one, this procedure has the advantage that it counteracts overheating of the hydraulic valve. For another, this also makes it possible to influence the pressure conditions in the brake circuit. For example, if the particular hydraulic valve is a reversing valve which controls the hydraulic supply in an hydraulic brake circuit, then a pressure release in the brake circuit is able to be achieved in a reversing valve that is open in a deenergized state. This procedure is useful in particular at low ambient temperatures, because an intake valve lying in the brake circuit opens more rapidly than the reversing valve due to a lower response time, so that pressure is locked in in the brake circuit and may have an undesired decelerating effect at the wheel brakes. By reducing the energization down to zero at the reversing valve and by the attendant opening of the reversing valve it is ensured that the enclosed pressure in the brake circuit is reduced and that an undesired decelerating effect at the wheel brakes is avoided.

Reducing the energization down to zero at the reversing valve may take place regularly, especially during the phases featuring low energization. In addition, however, it may also be useful to provide a brief reduction of the energization down to zero also at least in individual selected current peaks. As an alternative, instead of reducing the energization down to zero, it is reduced to a low value that preferably is less than the current value during the phases featuring low energization.

In addition, it is useful to briefly reduce the energization down to zero only at the reversing valve, but not at the intake valves, which take part in the energization, preferably together with the reversing valve, in order to heat the hydraulic fluid. An as option, a high-pressure switching valve, which controls the hydraulic supply from an hydraulic reservoir, also may participate in the energization for heating the hydraulic fluid.

For practical purposes, the entire method takes place in a closed-loop or open-loop control device, which preferably is part of the brake system.

### BRIEF DESCRIPTION OF THE DRAWINGS

FIG. 1 shows a portion of a brake system for a motor vehicle in a considerably schematized illustration.

FIG. 2 shows diagrams showing the current characteristic for heating the hydraulic fluid for an intake valve (upper diagram), for a reversing valve (center diagram) as a function of the time, as well as the characteristic of a pulse-width modulation for a high-pressure switching valve (lower diagram).

### DETAILED DESCRIPTION OF THE INVENTION

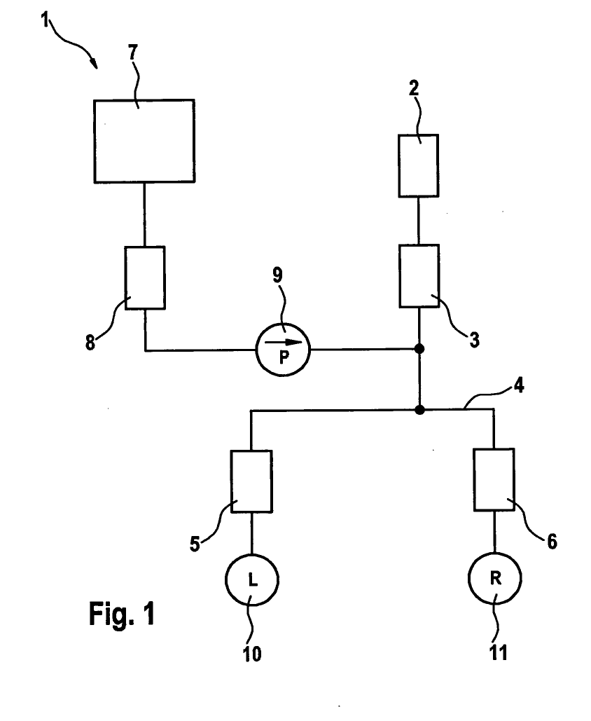

FIG. 1 shows a portion of an hydraulic brake system 1 for a motor vehicle, which includes wheel brake units 10 and 11 at, respectively, the left and right wheel of the vehicle. Brake system 1 has a main cylinder 2, which is actuated by the driver, and an electromagnetic hydraulic valve 3 postconnected to main cylinder 2, which functions as a reversing valve. Via a hydraulic valve 8 acting as high-pressure switching valve, and via a supply pump 9, hydraulic fluid from an hydraulic reservoir 7 is guided into brake circuit 4 for the supply of wheel brake units 10 and 11. Additional electromagnetic hydraulic valves 5 and 6, which act as intake valves, are connected upstream from wheel brake units 10 and 11 in brake circuit 4.

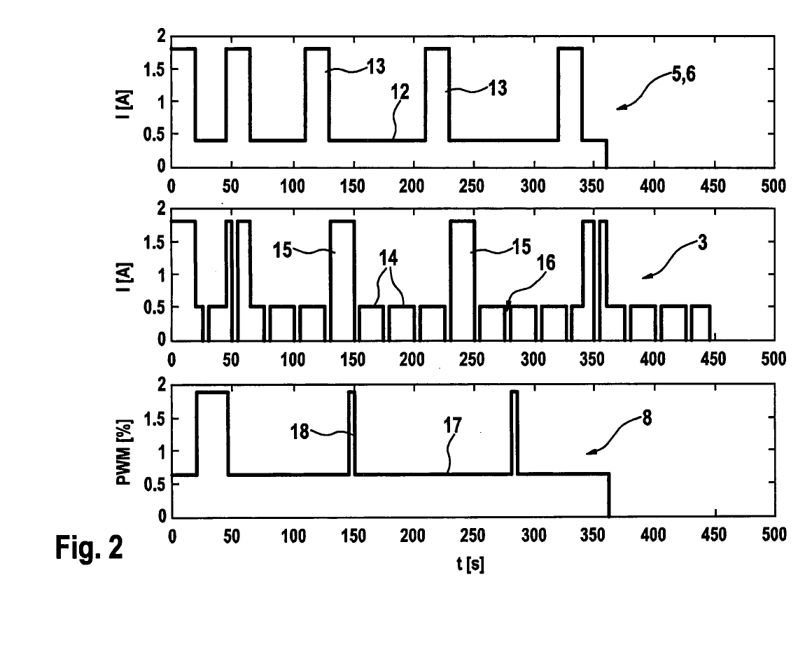

In order to heat the hydraulic fluid as quickly as possible especially at low outside temperatures, the different hydraulic valves are acted upon by phases of high and low current intensities during a heating period, which leads to heating of the hydraulic valves and thus results in the desired heating of the hydraulic fluid. Preferably, reversing valve 3 as well as intake valves 5 and 6 are acted upon by phases of high current intensity and low current intensity in a mutually adapted manner, which is illustrated in the diagrams according to FIG. 2. The upper diagram shows the temporal energization characteristic for intake valves 5 and 6 during the heating period, the center diagram shows the energization characteristic for reversing valve 3, and the lower diagram shows the characteristic of pulse-width modulation PMW for high-pressure switching valve 8.

In order to avoid an undesired high noise development in the energization of the hydraulic valves and a mechanical change in state that goes hand in hand with it, the hydraulic valves are energized in an adapted manner during a first phase following the startup of the drive motor of the motor vehicle, such that phases of high current intensity are set up at a mutual phase offset. In the upper diagram, which is assigned to intake valves 5 and 6, the phases of low current intensity are denoted by reference numeral 12, and the phases of high current intensity are denoted by reference numeral 13; in the center diagram, which relates to reversing valve 3, the phases of low current intensity are denoted by 14, the phases of high current intensity by 15, and the intermediate phases without energization are denoted by 16. The time period between two successive phases 13 featuring high current intensity for the intake valves increases over the course of the heating period; the same applies to the time period between successive phases 15 of high current intensity for reversing valve 3. For example, the time period of phase 12 having low energization is doubled, tripled or quadrupled, etc., and the same applies to the time period between two high current peaks 15 in the energization characteristic of reversing valve 3.

Directly following the startup phase, an individual high current peak 13 and 15 occurs in the energization characteristics both of intake valves 5 and 6 and reversing valve 3, the current peaks of intake valves and reversing valves coinciding immediately after the start and in the next high current peak as well. Starting with third current peak 13 and 15, however, they are mutually offset in phase; in the exemplary embodiment, first a high current peak 13 takes place in the energization characteristic of intake valve 5, 6, which is directly followed by a current peak 15 in the energization characteristic of reversing valve 3. This phase offset is maintained across the entire further heating course.

There is a multitude of regularly recurring trenches 16 in the energization characteristic of reversing valve 3, during which no energy input takes place. These trenches 16 preferably lie in the phases of low current intensity 14, but trenches of this kind may also be present in phases of high current intensity 15, which is the case in the second and in the fifth current peak of reversing valve 3 in the exemplary embodiment. Trenches 16, during which no energization takes place, are preferably implemented in periodically recurring manner, at the same period length.

The lower diagram according to FIG. 2 illustrates the characteristic of the pulse-width modulation of high-pressure switching valve 8, which is adjusted via a closed-loop voltage control. Phases featuring low voltage 17 and phases featuring high voltage 18 occur in the characteristic of the pulse modulation as well. This means that the high-pressure switching valve is also heated in phases during the heating period and thus takes part in the heating of the hydraulic fluid.

The phases having high level 18 may coincide both with a peak 15, e.g., in the current characteristic of reversing valve 3, and may also fall into a phase having low current intensity 14 of reversing valve 3 or 12 of intake valve 12 or 6.

The energization of the hydraulic valves at current intensities that differ at least intermittently is interrupted as soon as the brake and/or a vehicle regulation system are/is activated. In such a case the interruption of the current intensity takes place immediately or abruptly.

1-19. (canceled)

20. A method for operating a hydraulic brake system in a vehicle, comprising:
providing at least two electrically actuable hydraulic valves for the brake system; and
electrically energizing the hydraulic valves in phases to heat the hydraulic fluid, wherein the hydraulic valves are at least intermittently energized at different current intensities during the heating.

21. The method as recited in claim 20, wherein each hydraulic valve is acted upon by alternating phases of high current intensity and low current intensity for the heating.

22. The method as recited in claim 21, wherein the phases of high current intensity in the hydraulic valves are offset in phase relative to each other.

23. The method as recited in claim 22, wherein the phases of high current intensity in the hydraulic valves follow each other immediately.

24. The method as recited in claim 22, wherein the time duration of the phases of low current intensity increases from phase to phase in at least one hydraulic valve.

25. The method as recited in claim 24, wherein the time duration of the phases of high current intensity remains constant in at least one hydraulic valve.

26. The method as recited in claim 22, wherein, in a change in the current accompanied by a mechanical change in the switching state of a hydraulic valve, the transition in the current intensity has a ramp-type characteristic.

27. The method as recited in claim 24, wherein the energization is interrupted at least once during the heating in at least one hydraulic valve.

28. The method as recited in claim 27, wherein the energization is interrupted on a regular basis during the heating in the at least one hydraulic valve.

29. The method as recited in claim 28, wherein the energization is interrupted in phases of low energization.

30. The method as recited in claim 28, wherein the energization is interrupted in phases of high energization.

31. The method as recited in claim 28, wherein the energization during the heating is interrupted only in a portion of the hydraulic valves.

32. The method as recited in claim 22, wherein the energization of the hydraulic valves at intermittently different current intensities is interrupted as soon as at least one of the brake system and a vehicle regulation system is activated.

33. The method as recited in claim 22, wherein the energization of the hydraulic valves using different current intensities at least intermittently is activated only if the ambient temperature is below predetermined a temperature limit value.

34. A brake system, comprising:
at least two electrically actuable hydraulic valves; and
a control device configured to control electrically energizing the hydraulic valves in phases to heat the hydraulic fluid, wherein the hydraulic valves are at least intermittently energized at different current intensities during the heating, wherein the control device is one of a closed-loop or open-loop control device.

35. The brake system as recited in claim 34, wherein the control device is a closed-loop control device.

36. The brake system as recited in claim 34, wherein the hydraulic valves are implemented as at least one intake valve and as at least one reversing valve.

37. The brake system as recited in claim 34, wherein at least one of the hydraulic valves is implemented as a high-pressure switching valve.

38. The brake system as recited in claim 36, wherein the hydraulic valve whose energization is interrupted at least once during the heating is the reversing valve.
